(19) United States
(12) Patent Application Publication
(10) Pub. No.: US 2012/0123818 A1
(43) Pub. Date: May 17, 2012

(54) VIRTUAL MEETING SAVINGS

(76) Inventors: Lainye E. Heiles, Vancouver, WA (US); Ted Beers, Corvallis, OR (US); Lonnie D. Mandigo, Corvallis, OR (US)

(21) Appl. No.: 13/387,001

(22) PCT Filed: Jan. 18, 2010
(86) PCT No.: PCT/US2010/021325

§ 371 Date: Jan. 25, 2012

(51) Int. Cl. G06Q 10/06

(52) U.S. Cl. 705/7.13

(57) ABSTRACT

A method comprises receiving, by a processor, a number of participants for a virtual meeting and a home location for each participant. For each participant, the method further comprises ascertaining, by the processor, an environmental emissions savings associated with the participant in participating in the virtual meeting compared to having traveled to a corresponding meeting in-person.

### BACKGROUND

It is widely recognized that video conferencing can be more cost effective than an in-person meeting in which the meeting participants travel for an in-person meeting. For example, conducting a meeting by video conference between a person in Los Angeles and a person in Washington, D.C. is cheaper than if the person in Los Angeles flew to Washington, D.C. for the meeting. Video conferencing avoids costs that otherwise would have been incurred due to air fare, hotel, taxi fares, etc. Further, video conferencing generally results in a lower emission of greenhouse gases (e.g., CO₂) as traveling by car, taxi, airplane, etc. is avoided. Further still, video conferencing generally results in increased productivity as time is not spent traveling and therefore can be spent doing productive work.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows contents of a database in accordance with various embodiments;

FIG. 3 shows a graphical user interface in accordance with various embodiments;

FIG. 4 shows contents of a computer-readable storage medium in accordance with various embodiments;

FIG. 5 shows a method in accordance with various embodiments;

FIG. 6 shows another system in accordance with various embodiments;

FIG. 7 shows another graphical user interface in accordance with various embodiments; and

FIG. 8 shows another method graphical user interface in accordance with various embodiments.

### DETAILED DESCRIPTION

The term “virtual meeting” is used in this disclosure. A virtual meeting comprises an audio or audio/video discussion between individuals that are not face-to-face. A virtual meeting may comprise a telephone or voice over IP (audio only) discussion, as well as video conferencing (both audio and video). A virtual meeting may occur between two or more locations with audio and/or video conferencing equipment at each such location.

Various embodiments compute an estimate of savings associated with conducting a meeting virtually compared to its in-person, equivalent. More specifically, such embodiments determine the amount of savings in terms of any one or more travel costs, productivity, and greenhouse gas emissions in conducting a meeting virtually compared to conducting the same meeting in-person (i.e., face to face). Such savings estimates are useful for any of a variety of reasons. For instance, government regulations may require the reporting of greenhouse gas emissions with an eye toward lowering such emissions. Further, estimating cost, productivity, and greenhouse gas savings in conducting virtual meetings, rather than in-person meetings involving travel, may help to manage the operations of a business to help the organization lower its costs and increase production, while at the same time lowering its greenhouse gas footprint.

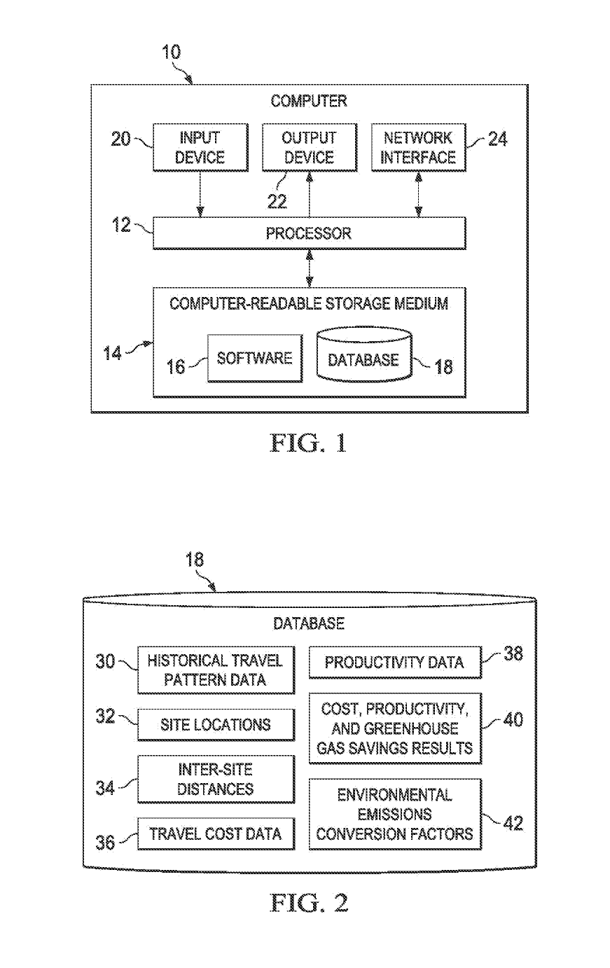

In accordance with various embodiments, a software tool, executable by a processor, performs such savings calculations. FIG. 1 shows a computer 10 in accordance with various embodiments. As shown, the computer 10 comprises a processor 12 coupled to a computer-readable storage medium (CRSM) 14, an input device 20, an output device 22, and a network interface 24. In some embodiments, the computer 10 may include multiple processors 12. References herein to the processor 12 refer to one or more processors.

The CRSM 14 comprises volatile memory (e.g., random access memory), non-volatile storage (e.g., hard disk drive, compact disc read-only memory (CDROM), etc.), or combinations thereof. The CRSM 14 comprises software 16 executed by processor 12 and a database 18. The software 16, when executed by the processor 12, provides the computer with some or all of the functionality described herein. The database 18 comprises one or more files in some embodiments that contain information such as that shown in FIG. 2 and described below.

The input device 20 comprises any suitable type of user input device such as a keyboard, mouse, trackball, touchpad, etc. The output device 22 comprises a display. The software 16 may be configured to implement a graphical user interface (GUI) that is shown on display 22. Via the input device 20, the user is able to provide information to, and select selectable features, on the GUI. The network interface 24 provides the computer with network connectivity to a local area network (LAN), a wide area network (WAN), a wireless network, etc. Through the network interface 24, the computer may access other computers and storage devices.

FIG. 2 provides an example of the contents that may be provided in the database 18. As shown in the example of FIG. 2, the database 18 comprises historical travel pattern data 30, site locations 32, inter-site distances 34, travel cost data 36, productivity data 38, and environmental emissions conversion factors 42, as well as results for various types of savings as will be explained below.

The historical travel pattern data 30 comprises such information as historically how often people travel from one of the organization's sites to another site for a meeting and which sites are involved in such travel. For example, the historical travel pattern data 30 may specify that, on average, personnel from an organization's Hong Kong site may have meetings with personnel in the organization's New York site seven times per year, and that on average five people from the Hong Kong site meet with eight people from the New York site. The historical travel pattern data 30 may also specify how many meetings are conducted virtually versus in-person. In some embodiments, the historical travel pattern data 30 comprises actual travel data of the organization's employees. In other embodiments, the historical travel pattern data 30 may represent the results of travel surveys of various organizations.

The site locations 32 comprise some or all sites of an organization. The various sites may be listed by city name (e.g., Los Angeles, Hong Kong, Paris, New York), by airport identifier, or in any other suitable manner.

The inter-site distances 34 indicates the distance (in miles, kilometers, etc.) between pairs of the sites ,specified in site locations 32. In other embodiments, the software 16 may access an on-line service to retrieve distance information rather than accessing such information from database 18.

Travel cost data 36 includes such information as, for each site pair, the typical price of air fare to fly from one member of the site pair to the other, typical prices for taxis in each site in the pair, typical hotel rates, etc. The cost data may be average cost data calculated over a period of time or contractually-set cost data. For example, the organization might have a special rate for a particular airline, hotel or hotel chain. Any and all costs that may be incurred as someone travels from one site in the pair to the other may be entered into travel cost data 36 in database 18.

Productivity data 38 comprises, in some embodiments, a productivity unit rate for each of various employees of the organization. A productivity unit rate for each employee represents the productivity value of that employee on a per unit of time basis (e.g., per hour). For example, some organizations charge customers by the hour for services rendered by the organization's employees. In that example, the productivity rate of such an employee, may comprise the price per unit of time that the organization charges customers for that employee's services (e.g., $100/hour). Other organizations may not charge customers for each hour worked by an employee. For such organizations, productivity may be specified based on the total compensation paid to a given employee (salary plus benefits) on a per unit of time basis (e.g., per day).

Environmental emissions (e.g., CO₂) conversion factors 42 might be provided as an amount of, for example, carbon dioxide that can be expected to be generated by someone traveling on an airplane on a per mile basis. Environmental emissions conversion factors may be in accordance with a known standard such as The Greenhouse Gas Protocol (GHG Protocol) established by the World Business Council on Sustainable Development.

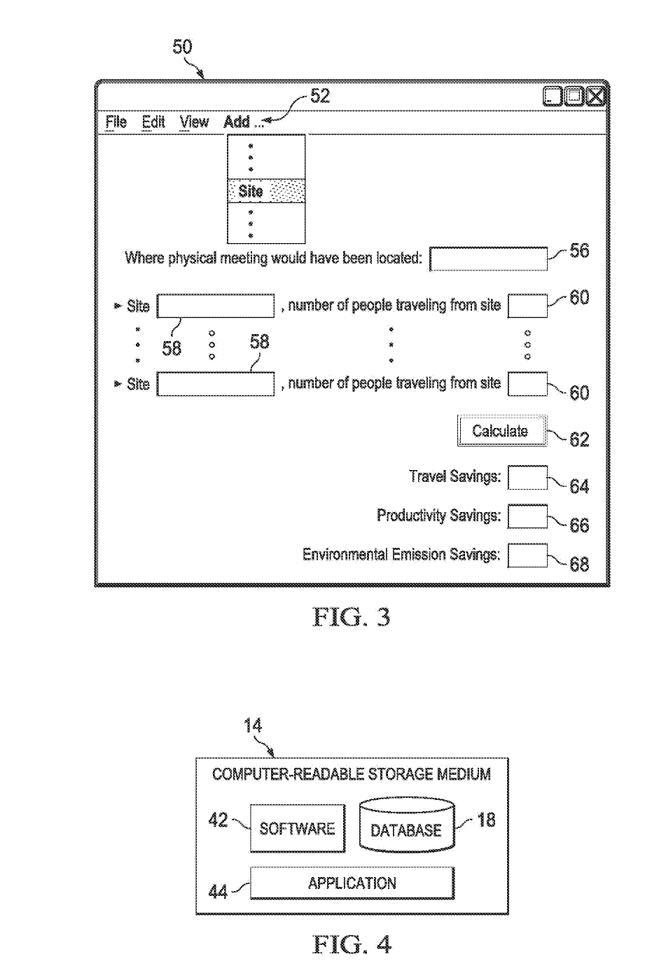

FIG. 3 illustrates a graphical user interface (GUI) 50 in accordance with some embodiments that may be implemented by software 16 when executed by processor 12 and shown on output device 22. The GUI 50 comprises various drop-down menu items 52 which, when selected by input, device 20, display one or more selectable features. A field 56 is provided in which the user of the software 16 can type in or otherwise select a location in which a meeting would have been located if the meeting had been conducted in person rather than virtually.

One of the menu items 52 listed in the illustrative GUI 50 is “Add.” When “Add” is selected, at least one of the add choices is to add a “site” to the GUI. An added site represents a site from which one or more of the meeting participants would have traveled to the destination site (field 56) if the meeting had been conducted in person. In field 58, the user provides the location of the site from which a number of participants (provided in field 60) would have traveled to arrive at the destination site identified in field 56. Additional sites can be added, via the “Add” menu choice 52 if participants from different locations are to participate in the video conference and would have traveled from different sites if the meeting had been conducted in person.

Once the information in GUI 50 is completed, the software 16 is provided with the location of the meeting if the meeting had been conducted in person, as well as the number of travelers and their site of origin to travel to the in-person meeting. A selectable button, such as “calculate” 62 can be selected by the user to command the software 16 to calculate the cost, productivity, and greenhouse gas emission savings of conducting the meeting virtually rather than in-person.

The software 16 determines the distance each traveler would have traveled to the hypothetical in-person by retrieving such distance information from inter-site distances 34 in database 18 or by accessing an on-line map service.

The software 16 computes any one or more of the following types of savings in conducting the meeting virtual versus in-person: travel cost savings, productivity savings, and environmental emission savings (sometimes referred to as Greenhouse Gas Savings).

Travel cost savings are computed using the travel cost data 36 from the database 18. For each person that would have traveled to the meeting if the meeting had been conducted in person, the software 16 is configured to compute the travel costs that that person would have incurred. For a traveling distance in excess of a predetermined or programmable amount (e.g., 150 miles), the person is assumed to have incurred, for example, a round-trip air fare, a hotel charge for the duration of the meeting (i.e., meetings may be held over the course, of one or more days), parking charges at their home airport, taxi fares, etc. The expected charges for these various expense items is obtained from travel cost data 36 in database 18. A travel cost estimate is computed for each such person that would have traveled for the hypothetical in-person meeting.

The software 16 also may be configured to offset the estimated travel costs for the traveling meeting participants by various overhead costs. Such overhead costs may include, for example, electricity costs in operating virtual meeting equipment (e.g., computers, networking devices, etc.), maintenance costs in servicing and repairing such equipment, telephone line charges, etc. The difference between the estimated travel costs for the participants and the overhead costs to permit virtual meetings represents the money saved in conducting the meeting virtually versus in-person.

Productivity can be measured in terms of units of currency or time (e.g., hours of lost productivity). For example, an organization may bill a client by the hour for services rendered by its employees. Law firms, accounting firms, etc. are examples of such organizations. When such an employee spends time traveling instead of working for a client, the organization loses the revenue that that employee would have generated for the organization if the employee had spent that time working for a client instead of traveling. For each meeting participant that would have traveled if the meeting had been conducted in-person, the participant is assumed not to have worked during the time the employee would have spent traveling. The software 16 accesses the productivity data 38 to retrieve the productivity unit rate of each such traveling meeting participant. The software 16 may multiply the time that the traveler would have spent traveling by the productivity unit rate of that particular traveler. For example, an organization normally may charge a customer $100/hour for time spent by a given employee on behalf of that customer. If that employee spends 8 hours traveling for a meeting, then the organization loses $800 in revenue that the employee otherwise would have generated for the organization.

Environmental emission savings can be computed based on the number of participants that would have traveled to the meeting, the distance each such traveler would have traveled to attend the meeting, and environmental emission conversion factors. The computed environmental emission conversion savings is specified by the software 16 in terms of amount (e.g., weight) of, for example, greenhouse gas emissions such as CO₂ that the meeting, participant's travel would have been responsible for generating.

In the example of FIG. 3, the software 16 calculates all three of travel savings, productivity savings, and greenhouse gas emission savings and provides such data in fields 64, 66, and 68, respectively. Further, the software 16 may also store the resulting savings in database 18 and specifically in the cost, productivity, and greenhouse gas emission savings 40 of database 18. Such savings 40 may comprise, an aggregate of the savings incurred over a period of time (e.g., per month, per year, etc.) for each meeting for which the software 16 computes the savings of conducting the meeting virtually rather than in-person. The software 16 adds the resulting savings to the corresponding previously aggregated savings from prior meetings to update the aggregation for each new meeting entered via GUI 50.

The greenhouse gas emissions estimated for the travelers may be offset by estimates of greenhouse gas emissions generated by the virtual meeting equipment (e.g., video conferencing equipment, computers) and electricity used to power the room in which such equipment is located. Such offsetting greenhouse gas emissions are computed based on, for example, the amount of electricity used to run the virtual meeting equipment.

The embodiment described above includes a GUI 50 that enables a user to enter information about a meeting and then command the software 16 to compute the savings in conducting such a meeting virtually rather than in-person. In other embodiments, the logic that computes the savings may comprise a “plug-in” to a scheduling application to avoid the user from having to enter the details regarding a meeting. FIG. 4, for example, illustrates the CRSM 14 of FIG. 1 in accordance with such an embodiment. As shown, CRSM 14 in FIG. 4 comprises the database 18, software 42, and a scheduling application 44 (e.g., Outlook by Microsoft). Software 42 comprises a plug-in for the scheduling application 44.

The scheduling application 44 implements ,a GUI that enables a user (a meeting “organizer”) to create a meeting event. The organizer uses the GUI to, for example, specify a date and time for the meeting, specifies whether the meeting is to be conducted virtually, specifies the location of the meeting (if the meeting is to be an in-person meeting), and specifies the participants. In some embodiments, the meeting is determined to, be virtual if a virtual resource node is invited instead of a human being. If the meeting is to be conducted virtually, the organizer also may identify the video conferencing endpoints (i.e., the locations of the video conferencing stations that the participants can use). Such video conferencing endpoints may be accessible to the scheduling application 44 in a similar fashion as email addresses for the participants.

Once the user creates the meeting, the plug-in 42 determines whether the meeting is to be conducted virtually or in-person. For virtual meetings, the plug-in 42 assumes the meeting would have occurred at the physical location of the meeting organizer and determines which, meeting participants are not located at that location. Those participants, or a subset thereof, would have traveled had the meeting been conducted in-person. Some of such participants might have preferred to dial in to the meeting by phone rather than travel anyway. Historical data may be used to estimate what percentage of the participants would have traveled had the meeting being conducted in-person. Factored into this assessment may be those participants whose participation in the meeting is required versus those participants whose participation is optional. The software may be configured to ignore optional participants and only analyze required participants. For each such participant that would have traveled, the plug-in 42 retrieves the distance from inter-site distance 34 in database 18 from that traveler's home location to the location for the meeting if the meeting had been conducted in-person. Further, corresponding travel data 36 and productivity data 38 are retrieved from database 18. Such data and greenhouse gas emission conversion factors are applied as described above to the meeting, had the meeting been conducted in-person, to compute travel savings, productivity savings, and greenhouse gas emission savings for having the meeting virtually.

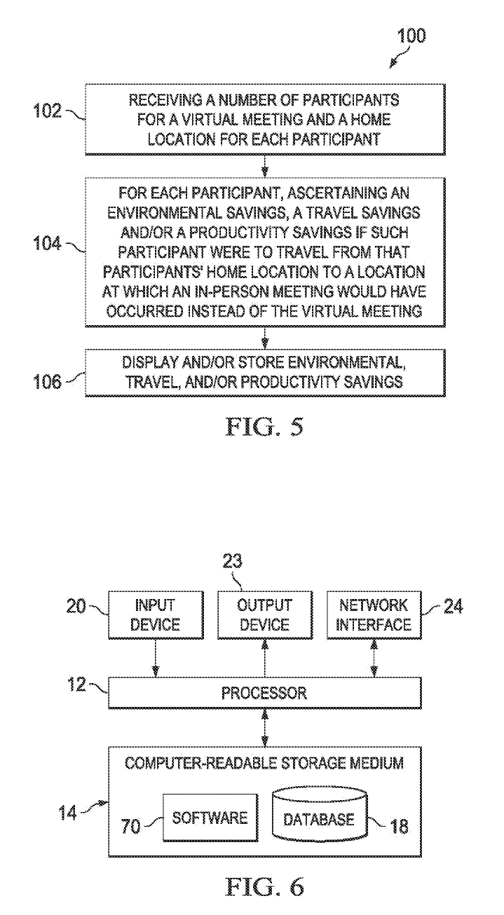

FIG. 5 illustrates a corresponding method 100 performed, for example, by software 16 and/or plug-in 42 executing on processor 12. At 102, the method comprises receiving a number of participants for a virtual meeting and a home location for each such participant. Each such participant is a participant that would have traveled had the meeting been conducted in-person. At 104, for each such participant, the method comprises ascertaining an environmental, travel, and/or productivity savings associated if such participant were to travel from that participant's home location to a location at which an in-person meeting would occur instead of the virtual meeting. The method ascertains these savings as described above. At 106, the method comprises displaying and/or storing the savings estimates.

Virtual meeting capabilities may include video conferencing equipment which may be a capital expenditure. Further, it may be that an organization's employees may not have much of a need to participate in many meetings over the course of given year. Thus, it is not universally the case that installing virtual meeting capabilities in every location of an organization makes the most economic sense. In accordance with various embodiments, a tool is provided that enables a decision to be made as to where to install virtual meeting capabilities for an organization.

FIG. 6 illustrates an embodiment of a system similar to that of FIG. 1, but the software stored on CRSM 14 is designated as software 70 to differentiate it from software 16 described above. In some embodiments, however, the functionality described below for software 70 could be implemented in software 16.

Software 70 uses and/or analyzes the historical travel pattern data 30 stored in database 18. As explained above, historical travel pattern data 30 specifies such information as historically how often people travel from one of the organization's sites to another site for a meeting and which sites are involved in such travel.

An organization may include n number of locations, where n is 2 or more. An n of 1 means that the organization has only a single location and virtual meeting capabilities is a moot, issue. The software 70 permits a user to specify two or more of the organization's locations to analyze in terms of virtual meeting capabilities. For a specified set of locations, the software uses the historical travel pattern data 30 associated with such locations to compute a “score” (explained below). The user can specify different combinations of 2 or more locations for which the software 70 will compute a score. The combination with the highest score is considered to be the particular combination of locations for which virtual meeting capabilities would be most beneficial.

Different users or different organizations may place value differently on one or more of travel cost savings, productivity savings, and environmental savings. For example, one organization may value environmental savings over travel cost savings, while another organization may value travel and productivity savings equally but slightly higher than environmental savings. Embodiments described herein permit a user to weight the various savings (productivity, travel, and environmental) equally or differently. The weights cause the software 70 to compute a weighted score as explained below.

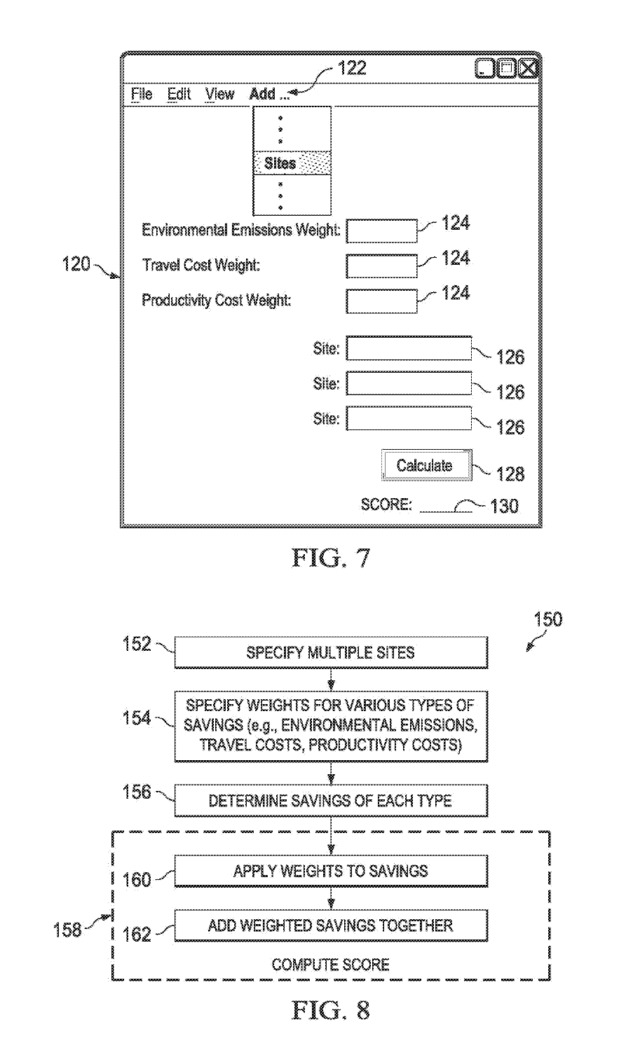

FIG. 7 provides an illustrative GUI 120 in accordance with some embodiments that may be implemented by software 70 when executed by processor 12 and shown on output device 22. The GUI 120 comprises various drop-down menu items 122 which, when selected by input device 20, display one or more selectable features.

One of the menu items 122 listed in the illustrative GUI 70 is “Add.” When “Add” is selected, at least one of the add choices is to add a “site” to the GUI. An added site represents a site from which one or more of the meeting participants would travel to a destination site if meetings were conducted in person. In field 126, the user provides the location of the added site. Additional sites can be added via the “Add” menu choice 122.

Fields 124 permit a user to enter weights for the various types of possible savings in conducting meetings virtually instead of in-person. Weights thus can be assigned for each of environmental emission savings, travel cost savings, and productivity cost savings.

Once the information in GUI 120 is completed, the user can select the “calculate” button 128 to command the software 70 to compute a score for the particular set of sites entered and weights. The score is displayed in field 130.

In some embodiments, the score is computed by determining each type of savings (environmental emissions, travel costs, and productivity costs) in having meeting virtually rather than in-person, multiplying each such savings by the respective weights and adding the weighted savings together to produce a score. Determining the savings of the various types is performed based on the historical travel pattern data 30, travel cost data 36, productivity data 38, and environmental conversion factors noted above. The historical travel pattern data 30 is indicative of the average number of meetings that occur from personnel in each site with personnel in each of the other sites and the average number of meeting participants. The travel cost data 36 indicates the average cost of airfares, taxi fares, hotel rates, etc. for a person to travel from one specified site to another specified site for a meeting. The productivity data 38 specifies the productivity rate for personnel in each site. The environmental conversion factors specify how much environmental emissions (e.g., CO2) are saved having a person remain at his or her home site for virtual meeting rather than physically traveling to the meeting. Such factors may be specified on a per unit of distance basis (e.g., X number of tons of CO2 saved per mile). The software 70 uses such data 30, 36,38, and environmental conversion factors to determine the environmental, travel, and productivity savings that were realized in conducting the meetings specified by the historical travel pattern data 30 virtually rather than in-person.

Table I below provides an example of such scoring. In Table I, two options are being considered. The hypothetical organization has 5 sites worldwide—Los Angeles (LA), New York City (NY), Beijing, Moscow, and Washington, DC. The organization wants to know in which of the sites virtual meeting capability should be installed. In Table I, the organization is analyzing two options. In Option 1, virtual meeting capability is deployed to LA, NY, and Beijing, while in Option 2, virtual meeting capability is deployed to all 5 sites. In the example of Table I, weights for each of the various savings types are provided. The weight for CO2 emission savings is 3, while the weights for travel and productivity savings are 2 and 1, respectively. Thus, in this example CO2 emissions are weighted greater than travel savings, and travel savings greater than productivity savings.

TABLE I
Sample Scoring for two options

| | | Option 1 (deploy | Option 2 (deploy |
|---|---|---|---|
| Objective | Wts | to LA, NY, Beijing) | to all 5 sites) |
| CO2 emission savings | 3 | 2*3 = 6 | 3*3 = 9 |
| Travel savings | 2 | 1*2 = 2 | 1*2 = 2 |
| Productivity savings | 1 | 1*1 = 1 | 2*1 = 2 |
| Final Scores for each | | 9 | 13 |
| alternative | | | |

For Option 1, CO2 emission savings, travel savings, and productivity savings are determined to be 2, 1, and 1, respectively. These numbers are provided simply to illustrate how scores are computed. The units of such numbers may be tons of CO2 savings or units of currency in the case of travel and productivity savings. Each of the savings is multiplied by its respective weight. Thus, for Option 1, the weighted savings for CO2 emission savings is 2*3, or 6. Similarly, the weighted savings for travel and productivity savings are 2 and 1, respectively. Adding the individual weighted, savings produces a score of 9.

For Option 2, the score is computed in a similar fashion. The individual savings components are different for CO2 emissions (3) and productivity savings (2) because a different set of sites have been selected. The weighted score for Option 2 is 13.

Comparing the weighted scores of Options 1 and 2 shows that the score of Option 2 (13) is higher than the score of Option 1 (9). The conclusion to be drawn from this analysis is that, based on how the various savings components are weighted, Option 2 (deploy virtual capability to all 5 sites) produces a better result in terms of various savings than Option 1 (deploy only to LA, NY, and Beijing). A different set of weights may produce a different result. Similarly, other combinations of sites can be analyzed as well using software 70.

FIG. 8 comprises a method 150 of computing a score, as, explained above by, for example, software 70 executing on processor 12. The various actions can be performed in the order shown, or in a different order. Further, two or more of the actions can be performed in parallel.

At 152, the method comprises specifying two or more sites to analyze. At 154, weights are specified for the various savings types (e.g., environmental emissions, travel costs, productivity costs). At 156, the method comprises determining the various types of savings as explained above.

At 158, a score is determined for the specified set of sites based on the various types of savings determined for those, sites and the weights. In one embodiment, determining the score comprises applying (160) the weights to the various types of, savings (e.g., multiplying each savings type by its respective weight) and adding the weighted savings together (162).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
receiving, by a processor, a number of participants for a virtual meeting and a home location for each participant; and
for each participant, ascertaining, by the processor, an environmental emissions savings associated with said participant in participating in said virtual meeting compared to having traveled to a corresponding meeting in-person.

2. The method of claim 1 further comprising for each participant, ascertaining a productivity cost savings associated with said participant in participating in said virtual meeting compared to having traveled to a corresponding meeting in-person.

3. The method of claim 1 further comprising for each participant, ascertaining a travel cost savings associated with said participant in participating in said virtual meeting compared to having traveled to a corresponding meeting in-person.

4. The method of claim 1 further comprising offsetting said environmental emissions savings by environmental emissions associated with the virtual meeting.

5. The method of claim 1 further comprising for each participant, ascertaining a productivity cost savings, and travel cost savings associated with said participant in participating in said virtual meeting compared to having traveled to a corresponding meeting in-person, and offsetting said environmental emission savings and said travel cost savings by environmental emissions and costs associated with the virtual meeting.

6. A computer-readable storage medium containing executable code that, when executed by a processor, causes the processor to:
receive a number of participants for a virtual meeting and a home location for each participant; and
for each participant, ascertain an environmental cost savings associated with said participant in participating in said virtual meeting compared to having traveled to a corresponding meeting in-person.

7. The computer-readable storage medium of claim 6 further comprising for each participant, the executable code causes the processor to ascertain a productivity cost savings associated with said participant in participating in said virtual meeting compared to having traveled to a corresponding meeting in-person.

8. The computer-readable storage medium of claim 6 further comprising for each participant, the executable code causes the processor to ascertain a travel cost savings associated with said participant in participating in said virtual meeting compared to having traveled to a corresponding meeting in-person.

9. The computer-readable storage medium of claim 8 wherein the code causes the processor to offset said travel and environmental costs for all participants in said virtual meeting to the overhead and environmental costs associated with the virtual meeting comprises.

10. A method, comprising:
specifying a plurality of sites; and
determining, based on historical travel pattern data and by the processor, travel cost savings, environmental emissions savings, and productivity savings in deploying virtual meeting capabilities to two or more locations compared to not having such virtual meeting capabilities at said specified plurality of sites.

11. The method of claim 10 wherein determining said travel cost savings, environmental emissions savings, and productivity, savings comprises assigning a weight to each of said travel cost savings, environmental emissions savings, and productivity savings.

12. The method of claim 11 further comprising multiplying said weights by said travel cost savings, environmental emissions savings, and productivity savings to produce weighted travel cost savings, weighted environmental emissions savings, and weighted productivity savings.

13. The method of claim 12 further comprising adding together said weighted travel cost savings, weighted environmental emissions savings, and weighted productivity savings to compute a score.

14. The method of claim 10 further comprising computing a score based on said travel cost savings, environmental emissions savings, and productivity savings.

15. The method of claim 10 wherein said historical travel pattern data comprises at least one of a number of travel events between a pair of locations.
